(19) United States
(12) Patent Application Publication
(10) Pub. No.: US 2023/0340373 A1
(43) Pub. Date: Oct. 26, 2023

(54) CLEANING WIPES

(71) Applicants: Shawn Dolan, Sterling Heights, MI (US); Lawrence Carlson, North Branch, MI (US)

(72) Inventors: Shawn Dolan, Sterling Heights, MI (US); Lawrence Carlson, North Branch, MI (US)

(73) Assignee: Tygrus LLC, Troy, MI (US)

(21) Appl. No.: 18/137,189

(22) Filed: Apr. 20, 2023

Related U.S. Application Data
(60) Provisional application No. 63/333,038, filed on Apr. 20, 2022.

(51) Int. Cl. C11D 3/43; C11D 17/04; C11D 1/88; C11D 3/48; C11D 3/20

(52) U.S. Cl. CPC C11D 3/43; C11D 17/049; C11D 1/88; C11D 3/48; C11D 3/2034; C11D 3/2079; C11D 3/2089; C11D 3/2082

(57) ABSTRACT

A cleaning wipe that is composed of a cleaning substrate and a cleaning composition that includes water and cleaning composition integrated therein. The cleaning composition comprises water and a liquid material component having between 0.5 and 2.0 M free hydrogen and between 100 ppm and 800 ppm calcium, the liquid material present in an amount capable of yielding a solution pH of 6.0 or below when present in the aqueous disinfectant composition together with a solubilizer present in an amount between 0 vol % and 5 vol %.

### BACKGROUND

The present application is a non-provisional Utility Application that claims priority to United States Provisional Utility Application Ser. No. 63,333,038, filed Apr. 20, 2022, currently pending, the specification of which is incorporated by reference herein.

The present disclosure pertains to cleaning wipes used to clean the surface on which they are applied. The present disclosure also pertains to wipes that are used to reduce or eliminate pathogen content on the surface to which they are applied. The present disclosure also pertains to cleaning wipes and compositions that can deposit one or more compounds or materials that can have a prolonged period of effectiveness against one or more pathogens. The present disclosure also pertains to compositions that can be integrated into cleaning wipe substrates.

Various hard surfaces can be contaminated with bacteria and other microorganisms which can present a risk to human health. Various antimicrobial compositions have been proposed or used on such surfaces. Certain antimicrobial compositions can pose problems such as leaving residue that requires a follow up rinsing step. Additionally, some antimicrobial compositions can result in undesirable filming and/or streaking.

In certain compositions, volatile organic solvents such as ethanol, butyl carbitol, n-butoxypropanol and the like can be included to enhance cleaning. In order to be effective, such compounds are included at sufficiently high concentrations to pose environmental and flammability concerns.

Cleaning wipes have been proposed for a variety of uses in a variety of venues. Various materials have been proposed for incorporation into woven and non-woven substrates in order to function as wet wipes for solid surface sanitizing. When cleaning wipes are employed in to apply various cleaning solutions, the issues of streaking and filming can be exacerbated. In certain configurations, the integration of the cleaning material into the wipe substrate and its effective release can be challenging.

Thus, it is desirable to provide a composition that can be effectively integrated into a cleaning wipe substrate. It is also desirable to provide a composition that can be effectively released upon application of the desired surface to be cleaned. It is also desirable to provide a composition that can provided effective and/or enhanced cleaning and/or antimicrobial treatment to a surface when applied by a suitable wet wipe. It is also desirable to provide wet wipes impregnated with a liquid composition that will provide enhanced cleaning and/or sanitizing effect when applied to a substrate surface.

### SUMMARY

Disclosed herein is a cleaning wipe that is composed of a cleaning substrate and a cleaning composition that includes water and cleaning composition integrated therein. The cleaning composition comprises water and a liquid material component having between 0.5 and 2.0 M free hydrogen and between 100 ppm and 800 ppm calcium, the liquid material present in an amount capable of yielding a solution pH of 6.0 or below when present in the aqueous disinfectant composition together with a solubilizer present in an amount between 0 vol % and 5 vol %.

### BRIEF DESCRIPTION OF THE DRAWINGS

The various features, advantages and other uses of the present apparatus will become more apparent by referring to the following detailed description and drawing in which:

FIG. 1 are mass spectra collected in the positive ionization mode for Dilute Sulfuric Acid w/400 ppm CaSO₄ (A), Dilute Sulfuric Acid (B), an embodiment as disclosed herein prepared according to the process outlined in Example I (C), and Reverse Osmosis Water (D); and

FIG. 2 are mass spectra collected in the negative ionization mode for Dilute Sulfuric Acid w/400 ppm CaSO₄ (A), Dilute Sulfuric Acid (B), and embodiment as disclosed herein prepared according to the process outlined in Example I (C), and Reverse Osmosis Water (D).

### DETAILED DESCRIPTION

Disclosed herein is a cleaning wipe construct that is composed of a cleaning substrate and a cleaning composition releasably contained in or associated with the substrate. The cleaning composition that is associated is water and a liquid material component having between 0.5 and 2.0 M free hydrogen and between 100 ppm and 800 ppm calcium, the liquid material present in an amount capable of yielding a solution pH of 6.0 or below when present in the aqueous disinfectant composition together with a solubilizer present in an amount between 0 vol % and 5 vol %.

The cleaning substrate employed in the cleaning wipe as disclosed herein is one that will permit absorption of a volume of the associated cleaning solution in an amount up to and including saturation and facilitate its controlled release when the substrate is placed in contact with a surface to be cleaned. It is contemplated that one or more cleaning wipes can be used to treat, clean and/or sanitize a target surface. It is contemplated that various target surfaces can be treated, cleaned and/or sanitized by use of one or more wipes applied charged with a volume of the associated cleaning solution to the target surface by a user or users.

It is contemplated that the substrate and associated cleaning solution can be used as a cleaner, disinfectant, sanitizer, and/or sterilant. As used herein, the term “disinfect” shall mean the elimination of many or all pathogenic microorganisms on surfaces with the exception of bacterial endospores. As used herein, the term “sanitize” shall mean the reduction of contaminants in the inanimate environment to levels considered safe according to public health ordinance, or that reduces the bacterial population by significant numbers where public health requirements have not been established. An at least 95% reduction in bacterial population within a 24-hour time period is deemed “significant.” As used herein, the term “sterilize” shall mean the complete elimination or destruction of all forms of microbial life and which is authorized under the applicable regulatory laws to make legal claims as a “sterilant” or to have sterilizing properties or qualities.

As used herein, the term “substrate” is intended to include any material that is used to clean an article or a surface. Examples of cleaning substrates include, but are not limited to nonwovens, sponges, films and similar materials, which can be attached to a cleaning implement, such as a toilet cleaning device. As used herein, “disposable” is used in its ordinary sense to mean an article that is disposed or discarded after a limited number of usage events, preferably less than 25, more preferably less than about 10, and most preferably less than about 2 entire usage events.

As used herein, “wiping” refers to any shearing action that the substrate undergoes while in contact with a target surface. This includes hand or body motion, substrate-implemented motion over a surface, or any perturbation of the substrate via energy sources such as ultrasound, mechanical vibration, electromagnetism, and so forth.

As used herein, the terms “nonwoven” or “nonwoven web” means a web having a structure of individual fibers or threads which are interlaid, but not in an identifiable manner as in a knitted web. Nonwoven webs have been formed from many processes, such as, for example, melt blowing processes, spinbonding processes, and bonded carded web processes.

As used herein, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

The term “cleaning solution”, as used herein is meant to mean and include one or more of the compounds or components disclosed herein.

A wide variety of materials can be employed as the cleaning substrate in the present disclosure. The material employed in the cleaning substrate will be one that is capable of holding a suitable quantity of cleaning solution and releasably transferring it for application to a surface to be cleaned or treated. Thus, suitable materials used in the cleaning substrate will exhibit one or more characteristics such as wet strength, loft, porosity, abrasivity and the like. Non-limiting examples of such cleaning substrate materials include nonwoven substrates, woven substrates, hydroentangled substrates, foams and sponges. Any of these substrates may be water-insoluble, water-dispersible, or water-soluble as desired or required.

In certain embodiments, the cleaning substrate can be a nonwoven substrate or web and can be composed of non-woven fibers or cellulose material such as paper. The term nonwoven is to be defined according to the commonly known definition provided by the “Nonwoven Fabrics Handbook” published by the Association of the Nonwoven Fabric Industry. A paper substrate is defined by EDANA (note 1 of ISO 9092-EN 29092) as a substrate comprising more than 50% by mass of its fibrous content is made up of fibers (excluding chemically digested vegetable fibers) with a length to diameter ratio of greater than 300, and more preferably also has density of less than 0.040 g/cm³.

Where desired or required, non-woven material employed in the cleaning substrate can be produced be various methods that include, but are not limited to, processes such as air-laying, water-laying, meltblowing, coforming, spunbonding, or carding processes in which the fibers or filaments are first cut to desired lengths from long strands, passed into a water or air stream, and then deposited onto a screen through which the fiber-laden air or water is passed. The resulting layer, regardless of its method of production or composition, may then be subjected to at least one of several types of bonding operations to anchor the individual fibers together to form a self-sustaining substrate. In the present disclosure, the nonwoven substrate can be prepared by a variety of processes including, but not limited to, air-entanglement, hydroentanglement, thermal bonding, and combinations of these processes.

The cleaning substrate can be partially or fully permeable to water. The cleaning substrate can be flexible and the substrate can be resilient, meaning that once applied external pressure has been removed the substrate regains its original shape.

Where desired or required, the cleaning substrate can be composed of one or more layers. Where multiple layers are employed, the materials can be bonded or connected to one another by any suitable mechanism.

The multiple layers can be composed of materials which are the same or different. It is contemplated that where multiple layers are employed in the cleaning substrate, the layers may be bonded to one another to maintain the integrity of the article. In certain embodiments, the various layers of the cleaning substrate can be heat spot bonded together or using heat generated by ultrasonic sound waves. The bonding may be arranged such that geometric shapes and patterns, e.g., diamonds, circles, squares, etc. are created on the exterior surfaces of the layers and the resulting article as desired or required.

It is contemplated that the cleaning substrates can be provided dry or can be pre-moistened, or impregnated with cleaning composition, but dry-to-the-touch. In certain embodiments, it is contemplated that the cleaning substrate can be provided in a pre-moistened or saturated condition. The pre-moistened or saturated cleaning substrates can be maintained over time in a sealable container such as, for example, within a bucket with an attachable lid, sealable plastic pouches or bags, canisters, jars, tubs and so forth. Where desired or required, the container can be resealable.

The cleaning substrates can be incorporated or oriented in the container as desired and/or folded as desired in to improve ease of use or removal. In certain embodiments, cleaning substrates as disclosed herein can be provided in a kit form, wherein a plurality of cleaning substrates and a cleaning tool are provided in a single package.

In certain embodiments, a plurality of cleaning substrates that are pre-moistened or saturated with the cleaning composition as disclosed herein can be maintained manner such that individual cleaning substrate units are serially available when desired. In certain embodiments, individual cleaning substrates can be maintained in a stacked manner relative to one another. In other embodiments, the cleaning substrate can be configured as a continuous sheet such that portions of the continuous sheet can be removed from the continuous sheet as desired or required. In certain embodiments, the continuous sheet can be configured with tear lines or perforations to facilitate such removal.

The cleaning substrate can include both natural and synthetic fibers. The substrate can also include water-soluble fibers or water-dispersible fibers, from polymers described herein. The substrate can be composed of suitable unmodified and/or modified naturally occurring fibers including cotton, Esparto grass, bagasse, hemp, flax, silk, wool, wood pulp, chemically modified wood pulp, jute, ethyl cellulose, and/or cellulose acetate. Various pulp fibers can be utilized including, but not limited to, thermomechanical pulp fibers, chemi-thermomechanical pulp fibers, chemi-mechanical pulp fibers, refiner mechanical pulp fibers, stone groundwood pulp fibers, peroxide mechanical pulp fibers and so forth.

Suitable synthetic fibers can comprise fibers of one, or more, of polyvinyl chloride, polyvinyl fluoride, polytetrafluoroethylene, polyvinylidene chloride, polyacrylics such as ORLON.RTM., polyvinyl acetate, Rayon, polyethylvinyl acetate, non-soluble or soluble polyvinyl alcohol, polyolefins such as polyethylene (e.g., Pulpex) and polypropylene, polyamides such as nylon, polyesters such as Dacron or Kodel, polyurethanes, polystyrenes, and the like, including fibers comprising polymers containing more than one monomer.

The cleaning substrate of as disclosed herein may be a multilayer laminate and may be formed by a number of different techniques including, but not limited to, using adhesive, needle punching, ultrasonic bonding, thermal calendering and through-air bonding. Such a multilayer laminate may be an embodiment wherein some of the layers are spunbond and some meltblown such as a spunbond/meltblown/spunbond (SMS) laminate. The SMS laminate may be made by sequentially depositing onto a moving conveyor belt or forming wire first a spunbond web layer, then a meltblown web layer and last another spunbond layer and then bonding the laminate in a manner described above. Alternatively, the three web layers may be made individually, collected in rolls and combined in a separate bonding step.

The cleaning substrate may also contain superabsorbent materials. The absorbent capacity of such high-absorbency materials is generally many times greater than the absorbent capacity of fibrous materials. For example, a fibrous matrix of wood pulp fluff can absorb about 7-9 grams of a liquid, (such as 0.9 weight percent saline) per gram of wood pulp fluff, while the high-absorbency materials can absorb at least about 15, preferably at least about 20, and often at least about 25 grams of liquid, such as 0.9 weight percent saline, per gram of the high-absorbency material.

The present disclosure also contemplates the use of a suitable cleaning wipes dispenser system or device. Suitable cleaning wipes dispenser systems can be configured to include both individually packaged disinfectant wipes and bulk packaged one or more disinfectant wipes or other suitable disinfecting articles. The dispenser system suitably comprises a sealable container, which is substantially impervious to both liquid and/or gas. The term “container”, refers to, but is not limited to, packets containing one or more individual wipes and bulk dispensers, such as canisters, tubs and jars, which dispense one disinfectant wipe at a time, and further feature suitable means to reseal the bulk dispenser between uses to preserve the integrity of the disinfecting articles. One example is a cylindrical canister dispenser that hosts a roll of individual wipes, separated by perforations to permit the tearing off of individual wipes for use. Such dispenser is conveniently gripped by the user and held in position while the user removes a wipe. Other examples can include rectangular containers, flexible envelops and the like.

In certain embodiments, the cleaning wipes dispenser can include a resealable dispensing cap and orifice that will permit the user to access a cleaning wipe or wipes and resealing of the dispenser when not in use. Where desired or required, it is contemplated that the wipe dispenser and/or the specific cleaning composition employed can be suitably configured to specific purposes that include infant wipes, personal care wipes, dishwashing wipes, hard surface treatment wipes, disinfectant wipes, cosmetic or sanitary wipes, hand wipes, wipes used in car cleaning, household or institutional cleaning or maintenance, computer cleaning and maintenance and any other area in which a flexible substrate having a useful liquid treatment composition has application.

In certain situations, it is contemplated that specific embodiments of the cleaning wipe as disclosed herein can be configured to be used with suitable cleaning implement(s) including but not limited to mops, high dusters, handle members and the like.

Where desired or required, the surface to be cleaned and/or treated can be wiped by contacting the cleaning wipe as disclosed herein. Examples of such surfaces include, but are not limited to counter surface, walls, mirror, fixtures, and the like. the process can include the steps of using enough wipes for the treated surface to remain visibly wet for 30 seconds or 1 minute or 2 minutes or 4 minutes, and letting the surface dry. For highly soiled surfaces, it may be necessary to clean excess dirt first. In one embodiment, the directions include wiping the surface to be disinfected with a wet cleaning wipe and allowing the surface to dry.

The cleaning composition that is present in the cleaning wipe can be an aqueous material. When the composition is an aqueous composition, water can be, along with the solvent, a predominant ingredient. The water can be present at a level of less than 99.9%, or less than about 99%, or less than about 95%. The water can be tap water, soft water, or deionized water. Where the cleaning composition is concentrated, the water may be present in the composition at a concentration of less than about 85 wt. %. In certain embodiments, when the cleaning composition is concentrated, the water component can be present in amounts less than 85 vol % ; less than 75 vol %; less than 65 vol %; less than 50%; less than vol 40%; less than 25 vol %; less than 10 vol.%.

The cleaning composition as disclosed herein includes a liquid material component having between 0.5 and 2.0 M free hydrogen and between 100 ppm and 800 ppm calcium, the liquid material present in an amount capable of yielding a solution pH of 6.0 or below when present in the aqueous disinfectant composition.

Where desired or required, the free hydrogen present in the liquid composition can be derived from one or more suitable inorganic acids present in whole or on part as a dissociated state. In certain embodiments, the suitable inorganic acid present in a whole or partially dissociated state can be selected from the group consisting of sulfuric acid, carbonic acid, oxalic acid, chromic acid, pyrophosphoric acid, phosphoric acid, and mixtures thereof. In certain embodiments, the inorganic acid component can be present in the aqueous disinfectant composition material solution in an amount between 1 vol % and 8 vol %; between 1 vol % and 7 vol %; between 1 vol % and 6 vol %; between 1 vol % and 5 vol %; between 1 vol % and 4 vol % between 1 vol % and 3 vol %; between 1 vol % and 2 vol %; between 2 vol % and 8 vol %; between 2 vol % and 7 vol %; between 2 vol % and 6 vol %; between 2 vol % and 5 vol %; between 2 vol % and 4 vol % between 2 vol % and 3 vol %; between 1 vol % and 8 vol %; between 1 vol % and 7 vol %; between 1 vol % and 6 vol %; between 1 vol % and 5 vol %; between 1 vol % and 4 vol % between 1 vol % and 3 vol %; between 1 vol % and 2 vol %; between 3 vol % and 8 vol %; between 3 vol % and 7 vol %; between 3 vol % and 6 vol %; between 3 vol % and 5 vol %; between 3 vol % and 4 vol %; between 4 vol % and 8 vol %; between 4 vol % and 7 vol %; between 4 vol % and 6 vol %; between 4 vol % and 5 vol %; between 5 vol % and 8 vol %; between 5 vol % and 7 vol %; between 5 vol % and 6 vol %; between 6 vol % and 8 vol %; between 6 vol % and 7 vol %; between 7 vol% and 8 vol %.

Where the free hydrogen content is associated with or derived from sulfuric acid, it is contemplated that the material will be present as a mixture of ions including one or more of hydrogen sulfate (HSO₄⁻), sulfate (SO₄²⁻), and calcium sulfate in soluble form. In the certain embodiments, the predominant ions present in the aqueous disinfectant formulation solution will be present as hydrogen sulfate (HSO₄⁻). The free hydrogen present in the liquid material can be between 0.5 M and 2.0M in certain embodiments; between 0.5 and 1.8M free hydrogen, between 0.5 and 1.6M; between 0.5 and 1.5M; between 0.5 and 1.3M; between 0.5 and 1.0M; between 0.5 and 0.8M; between 0.75 and 2.0; between 0.75 and 1.8M; between 0.75 and 1.7M; between 0.75 and 1.6M; between 0.75 and 1.5M; between 0.75 and 1.25M; between 0.75 and 1.0M; between 0.75 and 0.9M; between 1.0 and 2.0M and 1.0 and 1.8M; between 1.0 and 1.7M; between 1.0 and 1.6M; between 1.0 and 1.5M; between 1.0 and 1.25M.

The aforementioned compounds can be present in a suitable liquid material. Non-limiting examples of suitable materials include water of a sufficient purity level to facilitate the availability of the component materials and suitability for end-use applications. In certain embodiments, the water component of the liquid material can be material that is classified as ASTM D1193-06 primary grade. Where desired or required, the water component, the water can be purified by any suitable method, including, but not limited to, distillation, double distillation, deionization, demineralization, reverse osmosis, carbon filtration, ultrafiltration, ultraviolet oxidization, microporous filtration, electrodialysis and the like. In certain embodiments, was having a conductivity between 0.05 and 2.00 micro seimens can be employed. It is also within the purview of this disclosure that the water component of the liquid material can be composed of water having a purity greater than primary grade, if desired or required. Water classified as ASTM1193-96 purified, ASTM1193-96 ultrapure or higher can be used is desired or required.

The liquid composition component can also contain between 100 ppm and 800 ppm calcium with a major portion being present as calcium ions. In certain embodiments, the calcium ions can be present as Ca²⁺, CaSO₄, and mixtures thereof. In certain embodiments, the aqueous disinfectant formulation material can contain between 200 ppm and 800 ppm; between 300 ppm and 800 ppm; between 400 ppm and 800 ppm; between 500 ppm and 800 ppm; between 600 ppm and 800 ppm; between 700 ppm and 800 ppm; between 200 ppm and 700 ppm; between 300 ppm and 700 ppm; between 400 ppm and 700 ppm; between 500 ppm and 700 ppm; between 600 ppm and 700 ppm; between 200 ppm and 600 ppm; between 300 ppm and 600 ppm; between 400 ppm and 600 ppm; between 500 ppm and 600 ppm; between 200 ppm and 500 ppm; between 200 ppm and 400 ppm; between 200 ppm and 300 ppm.

The liquid material that is admixed to form the cleaning composition as disclosed herein can be produced by a variety of suitable means provided that the resulting material exhibits reduced or no harmful interaction with tissue such as mucosal tissue. One non-limited example or a suitable formulation process is as follows.

The liquid material as disclosed herein can be formed by the addition of a suitable inorganic hydroxide to a suitable inorganic acid. Suitable acids can have a density between 22° and 70° baume; with specific gravities between about 1.18 and 1.93. In certain embodiments, it is contemplated that the inorganic acid will have a density between 50° and 67° baume; with specific gravities between 1.53 and 1.85. The inorganic acid can be either a monoatomic acid or a polyatomic acid.

The inorganic acid employed can be homogenous or can be a mixture of various acid compounds that fall within the defined parameters. It is also contemplated that the acid may be a mixture that includes one or more acid compounds that fall outside the contemplated parameters but in combination with other materials will provide an average acid composition value in the range specified. The inorganic acid or acids employed can be of any suitable grade or purity. In certain instances, tech grade and/or food grade material can be employed successfully in various applications. Where desired or required, inorganic acids of even higher purity can be employed.

In preparing the liquid material as disclosed herein, the inorganic acid can be contained in any suitable reaction vessel in liquid form at any suitable volume. In various embodiments, it is contemplated that the reaction vessel can be non-reactive beaker of suitable volume. The volume of acid employed can be as small as 50 ml. Larger volumes up to and including 5000 gallons or greater are also considered to be within the purview of this disclosure.

The inorganic acid can be maintained in the reaction vessel at a suitable temperature such as a temperature at or around ambient. It is within the purview of this disclosure to maintain the initial inorganic acid in a range between approximately 23° and about 70° C. However lower temperatures in the range of 15° and about 40° C. can also be employed.

The inorganic acid is agitated by suitable means such as by a mechanical mixer operating to impart mechanical energy in a range between approximately 0.5 HP and 3 HP with agitation levels imparting mechanical energy between 1 and 2.5 HP being employed in certain applications of the process. Other suitable ranges for imparting levels of mechanical energy include between 0.5 HP and 2.5 HP; between 0.5 HP and 2.0 HP; between 0.5 HP and 2.0 HP; between 0.5 HP and 1.5 HP; between 0.5 HP and 1.0 HP; Between 1.0 HP and 3.0 HP; between 1.0 HP and 2.5 HP; between 1.0 HP and 2.0 HP; between 1.0 HP and 1.5 HP; between 1.5 HP and 3.0 HP; between 1.5 HP and 2.5 HP; between 1.5 HP and 2.0 HP; between 2.0 HP and 3.0 HP; between 2.5 HP and 3.0 HP.

Agitation can be imparted by a variety of suitable mechanical means including, but not limited to, DC servo drive, electric impeller, magnetic stirrer, chemical inductor and the like. Agitation can commence at an interval immediately prior to hydroxide addition and can continue for an interval during at least a portion of the hydroxide introduction step.

In the process as disclosed herein, the acid material of choice may be a concentrated acid with an average molarity (M) of at least 7 or above. In certain procedures, the average molarity will be at least 10 or above; with an average molarity between 7 and 10 being useful in certain applications. The acid material of choice employed may exist as a pure liquid, a liquid slurry or as an aqueous solution of the dissolved acid in essentially concentrated form.

Suitable acid materials can be either aqueous or non-aqueous materials. Non-limiting examples of suitable acid materials can include one or more of the following: hydrochloric acid, nitric acid, phosphoric acid, chloric acid, perchloric acid, chromic acid, sulfuric acid, permanganic acid, prussic acid, bromic acid, hydrobromic acid, hydrofluoric acid, iodic acid, fluoboric acid, fluosilicic acid, fluotitanic acid.

In certain embodiments, the defined volume of a liquid concentrated strong acid employed can be sulfuric acid having a specific gravity between 55° and 67° baume. This material can be placed in the reaction vessel and mechanically agitated at a temperature between 16° and 70° C.

In certain specific applications of the method disclosed, a measured, defined quantity of suitable hydroxide material can be added to an agitating acid, such as concentrated sulfuric acid, that is present in the non-reactive vessel in a measured, defined amount. The amount of hydroxide that is added will be that sufficient to produce a solid material that is present in the composition as a precipitate and/or a suspended solid or colloidal suspension. The hydroxide material employed can be a water-soluble or partially water-soluble inorganic hydroxide. Partially water-soluble hydroxides employed in the process as disclosed herein will generally be those which exhibit miscibility with the acid material to which they are added. Non-limiting examples of suitable partially water-soluble inorganic hydroxides will be those that exhibit at least 50% miscibility in the associated acid. The inorganic hydroxide can be either anhydrous or hydrated.

Non-limiting examples of water-soluble inorganic hydroxides include water soluble alkali metal hydroxides, alkaline earth metal hydroxides and rare earth hydroxides; either alone or in combination with one another. Other hydroxides are also considered to be within the purview of this disclosure. “Water-solubility” as the term is defined in conjunction with the hydroxide material that will be employed is defined a material exhibiting dissolution characteristics of 75% or greater in water at standard temperature and pressure. The hydroxide that is utilized typically is a liquid material that can be introduced into the acid material. The hydroxide can be introduced as a true solution, a suspension or a super-saturated slurry. In certain embodiments, it is contemplated that the concentration of the inorganic hydroxide in aqueous solution can be dependent on the concentration of the associated acid to which it is introduced. Non-limiting examples of suitable concentrations for the hydroxide material are hydroxide concentrations greater than 5 to 50% of a 5-mole material.

Suitable hydroxide materials include, but are not limited to, lithium hydroxide, sodium hydroxide, potassium hydroxide, ammonium hydroxide, calcium hydroxide, strontium hydroxide, barium hydroxide, magnesium hydroxide, and/or silver hydroxide. Inorganic hydroxide solutions when employed may have concentration of inorganic hydroxide between 5 and 50% of a 5-mole material, with concentration between 5 and 20% being employed in certain applications. The inorganic hydroxide material, in certain processes, can be calcium hydroxide in a suitable aqueous solution such as is present as slaked lime.

In the process as disclosed, the inorganic hydroxide in liquid or fluid form is introduced into the agitating acid material in one or more metered volumes over a defined interval to provide a defined resonance time. The resonance time in the process as outlined is considered to be the time interval necessary to promote and provide the environment in which the hydronium ion material as disclosed herein develops. The resonance time interval as employed in the process as disclosed herein is typically between 12 and 120 hours with resonance time intervals between 24 and 72 hours and increments therein being utilized in certain applications.

In various applications of the process, the inorganic hydroxide is introduced into the acid at the upper surface of the agitating volume in a plurality of metered volumes. Typically, the total amount of inorganic hydroxide material will be introduced as a plurality of measured portions over the resonance time interval. Front-loaded metered addition being employed in many instances. “Front-loaded metered addition”, as the term is used herein, is taken to mean addition of the total hydroxide volume with a greater portion being added during the initial portion of the resonance time. An initial percentage of the desired resonance time -considered to be between the first 25% and 50% of the total resonance time.

It is to be understood that the proportion of each metered volume that is added can be equal or can vary based on such non-limiting factors as external process conditions, in situ process conditions, specific material characteristics, and the like. It is contemplated that the number of metered volumes can be between 3 and 12. The interval between additions of each metered volume can be between 5 and 60 minutes in certain applications of the process as disclosed. The actual addition interval can be between 60 minutes to five hours in certain applications.

In certain applications of the process, a 100 ml volume of 5% weight per volume of calcium hydroxide material is added to 50 ml of 66° baume concentrated sulfuric acid in 5 metered increments of 2 ml per minute, with or without admixture. Addition of the hydroxide material to the sulfuric acid produces a material having increasing liquid turbidity. Increasing liquid turbidity is indicative of calcium sulfate solids forming as precipitate. The produced calcium sulfate can be removed in a fashion that is coordinated with continued hydroxide addition in order to provide a coordinated concentration of suspended and dissolved solids.

Without being bound to any theory, it is believed that the addition of a material such as calcium hydroxide to an acid such as sulfuric acid in the manner defined herein results in the consumption of the initial hydrogen proton or protons associated with the sulfuric acid resulting in hydrogen proton oxygenation such that the proton in question is not off-gassed as would be generally expected upon hydroxide addition. Instead, the proton or protons are recombined with ionic water molecule components present in the liquid material.

Solid material generated during the process and present as precipitate or suspended solids can be removed by any suitable means. Such removal means include, but need not be limited to, the following: gravimetric, forced filtration, centrifuge, reverse osmosis and the like.

The resulting liquid is a shelf-stable material that is believed to be shelf stable when stored at ambient temperature and between 50 and 75% relative humidity. In its concentrated state, the material can have a molarity between 1.87 to 1.78 molar and can contain between 3% and 10% of total moles of acid protons that are not charge balanced. In certain embodiments, the liquid material can contain between 4% and 9% of total moles of acid protons that are charge balanced; between 5% and 9% of total moles of charge balanced acid; between 6% and 9% of total moles of charge balanced acid; between 7% and 9% of total moles of charge balanced acid; between 8% and 9% of total moles of charge balanced acid.

It is contemplated that the resulting material can be further purified as suitable and can be employed as the liquid material in the aqueous material as disclosed herein. It is also within the purview of this disclosure to subject the resulting material to further processing as desired or required. Non-limiting examples of such processing can include subjecting the resulting fluid to as suitable magnetic field or fields.

In certain embodiments, the resulting liquid material can be subjected to a non-bi-polar magnetic field at a value greater than 2000 gauss; with magnetic fields greater than 2 million gauss being employed in certain applications. It is contemplated that a magnetic field between 10,000 gauss and 2 million gauss can be employed in certain situations. Other suitable ranges include between 10,000 gauss and 20,000 gauss; between 10,000 gauss and 30,000 gauss; between 10,000 gauss and 40,000 gauss; between 10,000 gauss and 50,000 gauss; between 10,000 gauss and 60,000 gauss; between 10,000 gauss and 70,000 gauss; between 10,000 gauss and 80,000 gauss; between 10,000 gauss and 90,000 gauss; between 10,000 gauss and 100,000 gauss; between 50,000 gauss and 100,000 gauss; between 50,000 gauss and 150,000 gauss; between 50,000 gauss between 200,000 gauss; between 50,000 gauss and 250,000 gauss; between 100,000 gauss and 200,000 gauss; between 100,000 gauss and 250,000 gauss; between 100,000 gauss and 300,000 gauss; between 100,000 gauss and 350,000 gauss; between 100,000 gauss and 400,000 gauss; between 100,000 gauss and 450,000 gauss; between 100,000 gauss and 500,000 gauss; between 250,000 gauss and 300,000 gauss; between 250,000 gauss and 400,000 gauss; between 250,000 gauss and 500,000 gauss; between 500,000 gauss and 600,000 gauss; between 500,000 and 700,000 gauss; between 500,000 gauss and 800,000 gauss; between 500,000 gauss and 900,000 gauss; between 500,000 gauss and 1,000,000 gauss; between 750,000 gauss and 1,100,000 gauss; between 750,000 gauss and 1,200,000 gauss; between 750,000 gauss and 1, 250,000 gauss; between 1,000,000 gauss and 1,100,000 gauss; between 1,100,000 gauss and 1,200,000 gauss; between 1,200,000 gauss and 1,300,000 gauss; between 1,300,000 gauss and 1,400,000 gauss; between 1,400,000 gauss and 1,500,000 gauss; between 1,500,000 gauss and 1,600,000 gauss; between 1,600,000 gauss and 1,700,000 gauss; between 1,800,000 gauss and 1,900,000 gauss; between 1,900,000 gauss and 2,000,000. The magnetic field can be produced by various suitable means. One non-limiting example of a suitable magnetic field generator is found in U.S. Pat. No. 7,122,269 to Wurzburger, the specification of which is incorporated by reference herein.

Solid material generated during the process and present as precipitate or suspended solids can be removed by any suitable means. Such removal means include, but need not be limited to, the following: gravimetric, forced filtration, centrifuge, reverse osmosis and the like.

The resulting liquid as disclosed herein is a shelf-stable viscous liquid that is believed to be stable for at least one year when stored at ambient temperature and between 50 to 75% relative humidity. The stable electrolyte composition of matter can be use neat in various end use applications. The stable electrolyte composition of matter can have a 1.87 to 1.78 molar material that contains 8 to 9% of the total moles of acid protons that are not charged balanced.

The liquid material that results from the process as disclosed herein can have a molarity between 200 M to 150 M strength and 187 to 178 M strength in certain instances, when measured titramtrically though hydrogen coulometry and via FTIR spectral analysis. The material has a gravimetric range greater than 1.15; with ranges greater than 1.9 in in certain instances. The material, when analyzed, is shown to yield up to 1300 volumetric times of orthohydrogen per cubic ml versus hydrogen contained in a mole of water.

It is contemplated that the liquid material as disclosed herein may serve as a source of acid protons when introduced into the aqueous material as contemplated herein. It has also been discovered, quite unexpectedly that the resulting material will present with a pH at 5.0 or below without the associated level of corrosivity. It is believed that the resulting composition contains an elevated level of acid protons present as HSO₄⁻. Without being bound by any theory, it is believed that elevated levels of HSO₄⁻ ions present in the resulting composition may moderate the corrosive characteristics of the cleaning composition material solution at a composition pH below 5.0; below 4.5; below 4.0; below 3.5; below 3.0; below 2.5; below 2.0. In certain embodiments, the composition pH can be between 1.5 and 3.5; between 2.0 and 3.5; between 2.5 and 3.5; 1.5 and 2.0; 1.5 and 2.5; 1.5 and 3.0; 2.0 to 3.0; 2.5 and 3.5; and 3.0 and 3.5.

Without being bound to any theory, it is believed that material prepared by the process as disclosed herein may contain and elevated level of hydronium ions that can be stably present, in the whole or in part, in the resulting biocompatible material. When present, the ion complex in the biocompatible material solution is generally stable and capable of functioning as an oxygen donor in the presence of the environment created to generate the same. The material may have any suitable structure and solvation that is generally stable and capable of functioning as an oxygen donor. Particular embodiments of the resulting solution will include a concentration of the ion as depicted by the following formula:

$$[ {H}_{x} {O}_{\frac{( x - 1 )}{2}} ] +$$

wherein x is an odd integer ≥3.

In certain embodiments, the hydronium ion can have a formula in which x is an odd integer ≥5. It is contemplated that ionic version of the compound as disclosed herein exists in unique ion complexes that have greater than seven hydrogen atoms in each individual ion complex which are referred to in this disclosure as hydronium ion complexes. As used herein, the term “hydronium ion complex” can be broadly defined as the cluster of molecules that surround the cation HₓOₓ₋₁+ where x is an integer greater than or equal to 3. The hydronium ion complex may include at least four additional hydrogen molecules and a stoichiometric proportion of oxygen molecules complexed thereto as water molecules. Thus, the formulaic representation of non-limiting examples of the hydronium ion complexes that can be employed in the process herein can be depicted by the formula:

$$[ {H}_{x} {O}_{\frac{( x - 1 )}{2}} + {( {H}_{2} O )}_{y} ]$$

where x is an odd integer of 3 or greater; and
y is an integer from 1 to 20, with y being an integer between 3 and 9 in certain embodiments.

In certain the hydronium ion will be present as a population of ion configurations with elevated levels of hydronium ions in which x is an odd integer that is 9 or greater. In certain embodiments, the hydronium ion will be present as a population of ion configurations with elevated levels of hydronium ions in which x is an odd integer that is 21 or greater.

In various embodiments disclosed herein, it is contemplated that at least a portion of the hydronium ion complexes will exist as solvated structures of hydronium ions having the formula:

Hₛ+xO_{2y}+
wherein x is an integer between 1 and 4; and
y is an integer between 0 and 2.

In such structures, an

$$[ {H}_{x} {O}_{\frac{( x - 1 )}{2}} ] +$$

core is protonated by multiple H₂O molecules. It is contemplated that the hydronium complexes present in the composition of matter as disclosed herein can exist as Eigen complex cations, Zundel complex cations or mixtures of the two. The Eigen solvation structure can have the hydronium ion at the center of an H₉O₄+structure with the hydronium complex being strongly bonded to three neighboring water molecules. The Zundel solvation complex can be an H₅O₂+complex in which the proton is shared equally by two water molecules. The solvation complexes typically exist in equilibrium between Eigen solvation structure and Zundel solvation structure. Heretofore, the respective solvation structure complexes generally existed in an equilibrium state that favors the Zundel solvation structure.

The present disclosure is based, at least in part, on the unexpected discovery that stable materials can be produced in which hydronium ion exists in an equilibrium state that favors the Eigen complex. The present disclosure is also predicated on the unexpected discovery that increases in the concentration of the Eigen complex in a process stream can provide a class of novel enhanced oxygen-donor oxonium materials.

The process stream as disclosed herein can have an Eigen solvation state to Zundel solvation state ratio between 1.2 to 1 and 15 to 1 in certain embodiments; with ratios between 1.2 to 1 and 5 to 1 in other embodiments.

The novel enhanced oxygen-donor oxonium material as disclosed herein can be generally described as a thermodynamically stable aqueous acid solution that is buffered with an excess of proton ions. In certain embodiments, the excess of protons ions can be in an amount between 10% and 50% excess hydrogen ions as measured by free hydrogen content.

Without being bound to any theory, it is believed that the process disclosed herein may result in the production of components such as those having the following general formula:

$$⌊ {H}_{x} {O}_{\frac{( x - 1 )}{2}} ⌋ {Z}_{y}$$

x is an odd integer ≥3;
y is an integer between 1 and 20; and
Z is one of a monoatomic ion from Groups 14 through 17 having a charge between −1 and −3 or a poly atomic ion having a charge between −1 and −3.

In the components as disclosed herein monatomic constituents that can be employed as Z include Group 17 halides such as fluoride, chloride, iodide and bromide; Group 15 materials such as nitrides and phosphides and Group 16 materials such as oxides and sulfides. Polyatomic constituents include carbonate, hydrogen carbonate, chromate, cyanide, nitride, nitrate, permanganate, phosphate, sulfate, sulfite, chlorite, perchlorate, hydrobromite, bromite, bromate, iodide, hydrogen sulfate, hydrogen sulfite. It is contemplated that the composition of matter can be composed of a single one to the materials listed above or can be a combination of one or more of the compounds listed.

It is also contemplated that, in certain embodiments, x is an integer between 3 and 9, with x being an integer between 3 and 7 in some embodiments and x being between 5 and 7 in some embodiments.

In certain embodiments, y is an integer between 1 and 10; while in other embodiments y is an integer between 1 and 5.

In certain embodiments, x is an odd integer between 3 and 12; y is an integer between 1 and 20; and Z is one of a group 14 through 17 monoatomic ion having a charge between −1 and −3 or a poly atomic ion having a charge between −1 and −3 as outlined above, some embodiments having x between 3 and 9 and y being an integer between 1 and 5.

In certain embodiments, the liquid material can contain is a stoichiometrically balanced chemical composition of at least one of the following: hydrogen (1+), triaqua-μ3-oxotri sulfate (1:1); hydrogen (1+), triaqua-μ3-oxotri carbonate (1:1), hydrogen (1+), triaqua-μ3-oxotri phosphate, (1:1); hydrogen (1+), triaqua-μ3-oxotri oxalate (1:1); hydrogen (1+), triaqua-μ3-oxotri chromate (1:1) hydrogen (1+), triaqua-μ3-oxotri dichromate (1:1), hydrogen (1+), triaqua-μ3-oxotri pyrophosphate (1:1), and mixtures thereof in admixture with water.

The cleaning composition as disclosed herein can also include a solubilizer present in an amount between 0 vol % and 5 vol %; between 0.5 and 5 vol %; between 1.0 and 5 vol %; between 1.5 and 5.0. vol %; between 2.0 and 5.0 vol % between 2.5 and 5.0 vol %; between 3.0 and 5.0 vol %; between 3.5 and 5.0 vol %; between 4.0 and 5.0 vol %.

Where employed, the solubilizer can be a surfactant material capable of solubilizing one or more active materials in an aqueous diluent such as water. Various anionic, zwitterionic and nonionic surfactants or mixtures thereof can be successfully employed in the compositions as disclosed herein. Suitable zwitterionic surfactants include, but are not limited to, materials such as lauryldimethylamine oxide, myristamine oxide, alkyl imidazolines, alkyl amines, as well as mixtures thereof. Non-limiting examples of suitable non-ionic surfactants include ethylene oxide adducts of C₈ to C₁₂ alcohols, ethylene oxide/propylene oxide adducts of ethylene glycol, alkylene glycols, and mixtures thereof. Non-limiting examples of suitable anionic surfactants include alkyl sulfonates and alkyl aryl sulfonates having about 8 to about 22 carbon atoms in the alkyl portion, alkali metal salts or mixtures thereof.

When present, the solubilizer such as a surfactant material can be present in an amount between 0 and 5 vol %; between 0.1 and 4.0 vol %; between 0.1 and 3.0 vol %; between 0.1 and 2 vol %; between 0.1 and 1 vol %; between 0.1 and 0.5 vol %.

Where desired or required, the cleaning composition can also include 0.1 vol. % and 5.0 vol % of at least one antimicrobial compound derived from at least one naturally derived material. “Naturally derived”, as the term is used herein, includes compounds that can be isolated from biological or botanical material. It is within the purview of this disclosure such material can be artificially synthesized if desired or required. It is contemplated that the active compound that is employed will include at least one phenyl group.

The active compound that is employed can have the general formula:

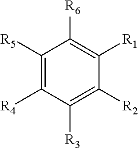

wherein R₁ is one of —OH, an alkenyl group having between 3 and 10 carbon atoms, or an alkoxy group having between 1 and 5 carbon atoms;
R₂ is one of an alkyl group having between 1 and 10 carbon atoms an alkoxy group have between 2 and 5 carbon atoms;
R₃ and R₆ is hydrogen;
R₄ is hydrogen, or an alkenyl group having between 3 and 10 carbon atoms and at least one double bond; and
R₅ is hydrogen or an alkoxy group having between 1 and 5 carbon atoms.

In certain embodiments, it is contemplated that the group R₁ can be an —OH group, an alkenyl group having 3 to 10 carbon atoms or an alkoxy group —OR₇ in which R₇ is alkyl group selected from the group consisting of methyl, ethyl, propyl, isopropyl, butyl and mixtures thereof. Where R₁ is an alkenyl group having between 3 and 10 carbon atoms, it is contemplated that group can have at least one double bone with certain embodiments having only one double bond. In certain embodiments, the at least one double bond can be located between the either the distal or proximal two carbon atoms in the alkenyl group. In certain embodiments, the alkenyl group can be selected from the group consisting of propenyl, butenyl, pentenyl, and mixtures thereof.

The group R₂ can be an alkyl group having between 1 and 10 carbon atoms or an alkoxy group having between 2 and 5 carbon atoms. In certain embodiments, the alkyl group can be one of the following: methyl, ethyl , propyl, isopropyl, n-butyl, t-butyl, sec-butyl, isobutyl, n-pentyl, tert-pentyl, neopentyl, isopentyl, sec-pentyl, 3-pentyl, sec-isopentyl and the like. In certain embodiments, the alkoxy group can be —OR₇ in which R₇ is alkyl group selected from the group consisting of methyl, ethyl, propyl, isopropyl, butyl and mixtures thereof.

The group R₄ is hydrogen, or an alkenyl group having between 3 and 10 carbon atoms and at least one double bond. In certain embodiments, the alkenyl group alkenyl group can have at least one double bone with certain embodiments having only one double bond. In certain embodiments, the at least one double bond can be located between the either the distal or proximal two carbon atoms in the alkenyl group. In certain embodiments, the alkenyl group can be selected from the group consisting of propenyl, butenyl, pentenyl, and mixtures thereof.

The group R₅ can be hydrogen or an alkoxy group having between 1 and 5 carbon atoms. In certain embodiments, the alkoxy group can be —OR₇ in which R₇ is alkyl group selected from the group consisting of methyl, ethyl, propyl, isopropyl, butyl and mixtures thereof.

In certain embodiments, the active compound can be selected from the group consisting of phenylpropanoids, monoterpenoid phenols, and mixtures thereof. Suitable phenylpropanoids can include various organic compounds that are synthesized y plant from amino acids phenylalanine and tyrosine. Suitable phenylpropanoid compounds can have a six-carbon phenyl group and a three-carbon propene tail. Non-limiting examples of suitable phenylpropanoid compounds can include compounds such as cinnamaldehyde, eugenol, chavicol, safrole, estragole and the like.

Suitable cinnamaldehyde compound can be present as either the cis isomer, the trans- isomer or mixtures thereof and can have the formula:

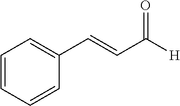

Where desired or required, the cinnamaldehyde can be incorporated in the composition as pure material. However, it is also within the purview of this disclosure to incorporate the essential oil of cinnamon back into the composition as disclosed herein. The cinnamaldehyde material can have a density of 1.0497 g/ml, a boiling point of 248 C and a refractive index of 1.6195 in its pure form.

Eugenol can be found in essential oils extracted from cloves, nutmeg, cinnamon, basil, bay leaf and the like. The material can have the general formula:

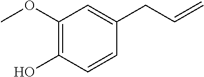

The material can have a molar mass of 164.2 g/mol, a boiling point of 254 C and a density of 1.06 g/cm³, a pKₐ of 10.19 at 25 C and a viscosity of 9.12 mPa at 20 C.

Monoterpenoid phenols suitable for use in the composition disclosed herein include but are not limited to thymol, carvacrol and the like.

The active compound as disclosed herein can be present in an amount sufficient to impart antimicrobial properties to the assocaited aqueous disinfectant composition when in admixture with one or more of the materials present therein. In certain embodiments, the active compound or compounds as disclosed herein can be present in an amount between 0.1 and 5.0 vol %. In certain embodiments, the active compound can be present in amounts between 0.1 and 4.0 vol %; between 0.1 and 3 vol %; between 0.1 and 2.0 vol %; between 0.1 and 1.0 vol %; between 0.1 and 0.5 vol %; 0.1 and 0.25 vol %; between 0.2 and 4.0 vol %; between 0.2 and 3.0 vol %; between 0.2 and 2.0 vol %; between 0.2 and 1.0 vol %; between 0.2 and 0.5 vol %; 0.2 and 0.25 vol %; between 0.2 and 4.0 vol %; between 0.3 and 3.0 vol %; between 0.3 and 2.0 vol %; between 0.3 and 1.0 vol %; between 0.3 and 0.5 vol %; between 0.5 and 4.0 vol %; between 0.5 and 3.0 vol %; between 0.5 and 2 vol %; between 0.5 and 1 vol %; between 1.0 and 4.0 vol %; between 1.0 and 3 vol %; between 1.0 and 2.0 vol %; between 2.0 and 4.0 vol %; between 2.0 and 3.0 vol %.

The active material as disclosed herein can be present as a single compound or in suitable admixture with one or more active compounds. The present disclosure is predicated, at least in part on the unexpected discovery that the aforementioned active compound(s) can exhibit antimicrobial activity or enhanced antimicrobial activity when present in admixture in the composition as disclosed herein. It has been found unexpectedly compositions as disclosed herein, when applied to surfaces such as hard surfaces can reduce or eliminate pathogens present on the assocaited surface.

Non-limiting examples of such pathogens can include pathogens such as such as those within the family Paramyxoviridae (such as measles morbillivirus), Herpesviridae (such as varicella-zoster virus); Mycobacteriaceae (such as Mycobacterium tuberculosis); Orthomyxoviridae (such as influenzavirus A, influenzavirus B); Picornavivdae (such as enterovirus, poliovirus, coxsackie A viruses, coxsackie B viruses and the like); Calicivirdae (such as noroviruses); Coronaviridea including the subfamily Orthocoronavirinae (such as beta coronaviruses like SARS-CoV, SARS-CoV-2, MERS-CoV); Adenoviridae and the like, Staphylococcaceae (such as Staphyloccoccus aureus, like methicillin-resistant Staphylococcus aureus); Enterococcaceae (including vancomycin-resistant enterococci), Streptococcaceae (including streptococci) gram positive species such as Clostridioides difficile, Listeria, Coynebacterium and the like.

Where desired or required, the free hydrogen present in the liquid composition can be derived from one or more suitable inorganic acids in whole or on part as a dissociated state. In certain embodiments, the suitable inorganic acid present in a whole or partially dissociated state can be selected from the group consisting of sulfuric acid, carbonic acid, oxalic acid, chromic acid, pyrophosphoric acid, phosphoric acid, and mixtures thereof. In certain embodiments, the inorganic acid component can be present in the aqueous disinfectant composition material solution in an amount between 1 vol % and 8 vol %; between 1 vol % and 7 vol %; between 1 vol % and 6 vol %; between 1 vol % and 5 vol %; between 1 vol % and 4 vol % between 1 vol % and 3 vol %; between 1 vol % and 2 vol %; between 2 vol % and 8 vol %; between 2 vol % and 7 vol %; between 2 vol % and 6 vol %; between 2 vol % and 5 vol %; between 2 vol % and 4 vol % between 2 vol % and 3 vol %; between 1 vol % and 8 vol %; between 1 vol % and 7 vol %; between 1 vol % and 6 vol %; between 1 vol % and 5 vol %; between 1 vol % and 4 vol % between 1 vol % and 3 vol %; between 1 vol % and 2 vol %; between 3 vol % and 8 vol %; between 3 vol % and 7 vol %; between 3 vol % and 6 vol %; between 3 vol % and 5 vol %; between 3 vol % and 4 vol %; between 4 vol % and 8 vol %; between 4 vol % and 7 vol %; between 4 vol % and 6 vol %; between 4 vol % and 5 vol %; between 5 vol % and 8 vol %; between 5 vol % and 7 vol %; between 5 vol % and 6 vol %; between 6 vol % and 8 vol %; between 6 vol % and 7 vol %; between 7 vol% and 8 vol %.

It is also contemplated that the cleaning composition as disclosed herein can also contain a suitable short-chain alcohol component. It is contemplated that the short-chain alcohol component, when present, can be present in an amount between 0.1 and 50 vol %, with concentrations between 0.1 and 3 vol % being employed in certain embodiments. Examples of suitable alcohols, include but are not limited to, C₁ to C₆ straight-chained or branched alcohols such as ethanol, methanol, propanol, isopropanol, butanol and mixtures thereof.

In certain embodiments, the formulation can also include one or more weak organic acids which, when present, can be present in amounts between 0.1 and 2% and can be selected from the group consisting of and acetic acid, hydroxyacetic acid, citric acid, tartaric acid, maleic acid, fumaric acid and mixtures thereof.

The formulation, as disclosed herein, can also include a carboxylic acid component composed of ca carboxylic acid having the general formula:

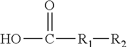

wherein R₁ is an unsaturated hydrocarbon moiety having between four and fourteen carbon atoms or a hydrocarbon moiety having between four and fourteen carbon atoms and at least one double bond; and
wherein R₂ is a one of —H, —OH, or —CH_{3.}
   In certain embodiments, the carboxylic acid compound can be selected from the group consisting of hexanoic acid, octanoic acid, decanoic acid, dodecanoic acid and mixtures thereof When present the formulation, the carboxylic acid component can be present in an amount between 0.1 and 3.0 vol %.

In order to further illustrate the present disclosure, the following examples of presented. The Examples are for illustration purposes and are not to be considered limitative of the present disclosure.

### EXAMPLE I

In order to assess the efficacy of the cleaning composition as disclosed herein, material is prepared by the following method. Several units of (50) ml of concentrated liquid sulfuric acid having a mass fraction H₂SO₄ of 98%, an average molarity (M) above 7 and a specific gravity of 66° baume are placed in respective non-reactive vessels and maintained at 25° C. with agitation by a magnetic stirrer to impart mechanical energy of 1 HP to the liquid.

Once agitation has commenced, a measured quantity of sodium hydroxide is added to the upper surface of each of the agitating acid material. The sodium hydroxide material employed is a 20% aqueous solution of 5M calcium hydroxide and is introduced into each of the respective units in five metered volumes introduced at a rate of 2 ml per minute over an interval of five hours with to provide a resonance time of 24 hours. The introduction interval for each metered volume is 30 minutes.

Turbidity is produced in the units with addition of calcium hydroxide to the sulfuric acid indicating formation of calcium sulfate solids. The solids in each unit are permitted to precipitate periodically during the process and the precipitate is removed from contact with the reacting solutions.

Upon completion of the 24-hour resonance time, the resulting material are each exposed to a non-bi-polar magnetic field of 2400 gauss resulting in the production of observable precipitate and suspended solids for an interval of 2 hours. The resulting material units are centrifuged and force filtered to isolate the precipitate and suspended solids from each the liquid material unit.

The liquid material that is produced is separated as individual samples. Some are stored in closed containers at standard temperature and 50% relative humidity to determine shelf-stability. Other samples are subjected to analytical procedures to determine composition. The test samples are subjected to FTIR spectra analysis and titrated with hydrogen coulometry. The sample material has a molarity ranging from 187 to 178 M strength. The material has a gravimetric range greater than 1.15; with ranges greater than 1.9 in in certain instances. The composition is stable and has a 1.87 to 1.78 molar material that contains 8 to 9% of the total moles of acid protons that are not charged balanced. Liquid material is collected for further use and analysis.

### EXAMPLE II

A second embodiment of the liquid material as disclosed herein is prepared by introducing 50 ml units of concentrated liquid sulfuric acid having a mass fraction H₂SO₄ of 98%, an average molarity (M) above 7 and a specific gravity of 66° baume into a non-reactive vessel and maintaining each at 25° C. with agitation by a magnetic stirrer to impart mechanical energy of 1 HP to the each liquid unit.

Once agitation has commenced, a measured quantity of sodium hydroxide is added to the upper surface of the agitating acid material of each liquid unit. The sodium hydroxide material employed is a 20% aqueous solution of 5M calcium hydroxide and is introduced in five metered volumes introduced at a rate of 2 ml per minute over an interval of five hours with to provide a resonance time of 24 hours. The introduction interval for each metered volume is 30 minutes.

Turbidity is produced with addition of calcium hydroxide to the sulfuric acid indicating formation of calcium sulfate solids. The solids in each unit are permitted to precipitate periodically during the process and the precipitate is removed from contact with the reacting solution.

Upon completion of the 24-hour resonance time, the resulting material is centrifuged and force filtered to isolate the precipitate and suspended solids from the liquid material and respective resulting material units are collected for further use and analysis.

### EXAMPLE III

A 5 ml portion of the material produced according to the method outlined in Example I is admixed in a 5 ml portion of deionized and distilled water at standard temperature and pressure. The excess hydrogen ion concentration is measured as greater than 15% by volume and the pH of the material is determined to be 1.

### EXAMPLE IV

To further evaluate the materials prepared in Examples I and II, samples of the materials are diluted with deionized water to provide material that contains 1% by volume of the respective material in water. These samples are evaluated against a dilute sulfuric acid solution, a dilute sulfuric acid solution with to which calcium sulfate is added to yield 300 ppm and a dilute sulfuric with 400 ppm calcium sulfate and well as a reverse osmosis water control.

All samples are diluted in an acid matrix for analysis. The testing is completed using a Thermo iCAP 6300 Duo ICP-OES for calcium and sulfur content following EPA method 200.7.

Each test material is initially prepared by simple dilution in a 5% nitric acid matrix. The calibration standards are prepared in the same acid matrix to match the samples. However this preparation leads to high recoveries for calcium which is believed to be a result of the sulfuric acid present in the samples but not present in the calibration standards. The calibration standards are re-prepared with a small amount of sulfuric acid in order to match the samples, and the analysis repeated in order to provide better QC recoveries that approach 100%.

In order to test for conductivity the samples are each diluted with de-ionized water for analysis. The testing is completed using a Mettler Toledo Seven Excellence Meter with a conductivity probe following EPA method 120.1. Predicted conductivity results are presented in Table I.

TABLE I
Summary of Conductivity Results

| Sample Name | Conductivity, mS/cm |
|---|---|
| Dilute sulfuric acid | 556 |
| Example I Sample | 551 |
| Example II Sample | 552 |
| Reverse Osmosis Water | 3.2 (μS/cm) |
| Dilute Sulfuric Acid w/300 ppm CaSO₄ | 562 |
| Dilute Sulfuric Acid w/400 ppm CaSO₄ | 558 |

In order to evaluate freezing point, the samples are analyzed using a TA Instruments Q100 DSC equipped with an RCS-90 cooling system following USP <891>. Predicted results are presented in Table II.

TABLE II
Summary of Freeze Point Results

| | Melting |
|---|---|
| Sample Name | Temperature, ° C. |
| Dilute sulfuric acid | −8.73 |
| Example I | −9.07 |
| Example II | −9.05 |
| Reverse Osmosis Water | 0.83 |
| Dilute Sulfuric Acid | −9.27 |
| w/400 ppm CaSO₄ | |

The density and specific gravity of the samples are determined at 20° C. using an Anton Paar digital density meter following EPA method 830.7300. predicted results are presented in Table III.

TABLE III
Summary of Density and Specific Gravity Results

| | Density | Specific |
|---|---|---|
| Sample Name | g/cm³ | Gravity |
| Dilute sulfuric acid | 1.0384 | 1.0403 |
| Example I | 1.0403 | 1.0422 |
| Reverse Osmosis Water | 0.9982 | 1.0000 |
| Dilute Sulfuric Acid | 1.0400 | 1.0418 |
| w/400 ppm CaSO₄ | | |

The samples are also titrated for hydrogen ion content with acidity being determined following ASTM D1067-Test Method A to a pH of 8.6. The testing was completed using a Metrohm 826 Titrando equipped with a pH probe. Predicted results are presented in Table IV.

TABLE IV
Summary of Acidity (Titration) Results

| Sample Name | Acidity @ pH 8.6, meq/L |
|---|---|
| Dilute sulfuric acid | 1276.76 |
| Example I | 1307.28 |
| Example II | 1305.00 |
| Reverse Osmosis Water | 0.08 |
| Dilute Sulfuric Acid w/300 ppm CaSO₄ | 1295.68 |
| Dilute Sulfuric Acid w/400 ppm CaSO₄ | 1260.36 |

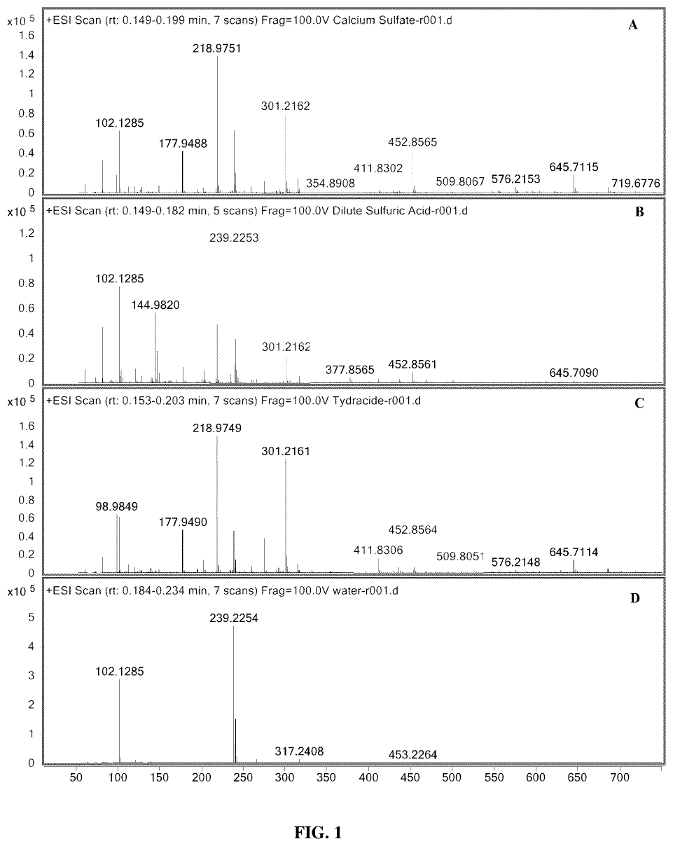

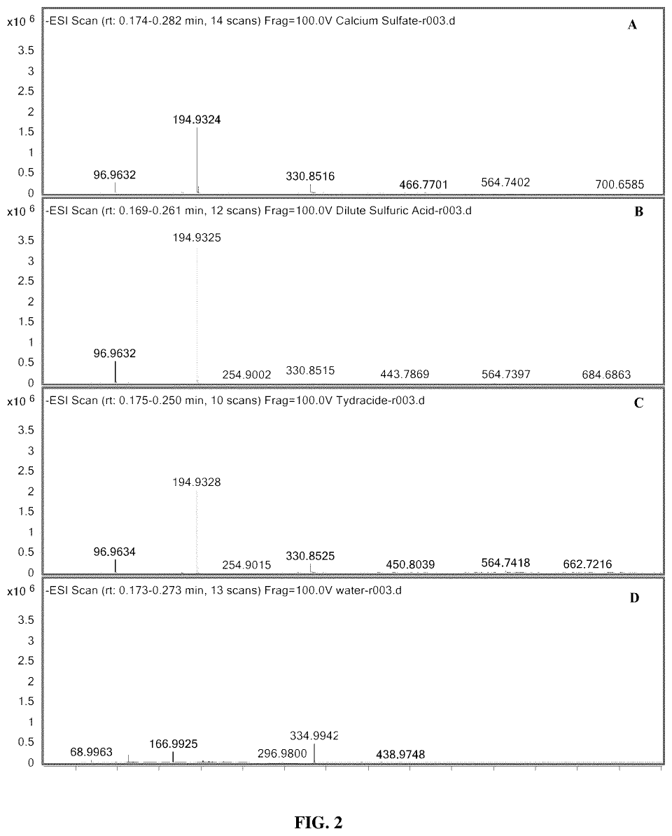

Solutions were analyzed an Agilent 1290/G6530 Q-TOF LC-MS using direct infusion (no column) and electrospray ionization in the positive and negative modes. Representative mass spectra collected in the positive and negative ionization modes are shown in FIGS. 1 and 2 with for Dilute Sulfuric Acid w/400 ppm CaSO₄ (A), Dilute Sulfuric Acid (B), Tydracide (C), and Reverse Osmosis Water (D).

### EXAMPLE V

The respective samples of Example I are diluted to produce 5 volume % of the product in water and are found to be shelf stable for at least 12 to 18 months. The excess hydrogen ion concentration is measured to be greater than 15% and the pH of the material is determined to be 1.

### EXAMPLE VI

In order to ascertain the effectiveness of various embodiments of the formulation as disclosed herein, compositions are prepared as outlined in the Table V using the percentages of the liquid material described in Example I at concentrations of 2.4 vol % or 4.8 vol % respectively in water. A composition is also prepared according to the present disclosure incorporated sulfuric acid to equal the concentration the composition of Example I at 2.4 vol % for comparison.

TABLE V

| | | | | | Ammonyx | | |
|---|---|---|---|---|---|---|---|
| | | Carva- | Cinnaml- | Euge- | LO | Ethanol | |
| | Thymol | crol | dehyde | nol | surfactant | 100% | Ex I |
| Vari- | Vol | Vol | Vol | Vol | Vol | Vol | Vol |
| ation | % | % | % | % | % | % | % |
| 1 | 1.0 | | | | | 2.0 | 2.4 |
| 2 | 0.1 | | | | | | 2.4 |
| 3 | 1.0 | | | | 0.51 | 1.0 | 2.4 |
| 4 | | 1.0 | | | 0.51 | | 2.4 |
| 5 | | | 1.0 | | 0.51 | | 2.4 |
| 6 | | | | 1.0 | 0.51 | | 2.4 |
| 7 | 1.0 | | | | | 2.0 | 4.8 |
| 8 | | 1.0 1 | | 2.0 | | | 4.8 |
| 9 | 1.0 | | | | 1.0 | 2.0 | 4.8 |

The respective materials are free flowing liquids that could be wiped, sprayed or misted onto hard surfaces.

### EXAMPLE VII

The formulations of Examples VI are evaluated to determine whether the respective material kills, in 10-minutes contact time at least 57 of 60 carriers/lot against Staphylococcus aureus and at least 54 of 60 carriers/lot against Pseudimonas aeruginosa using AOAC Official Method 955.15 against S. aureus and AOAC Official Method 964.02 against P. aeruginosa. The various materials exhibit between log 6.0 reduction or greater within the test interval.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A cleaning wipe comprising:
a cleaning substrate; and
a cleaning composition, the cleaning composition comprising:
water;
a liquid material component having between 0.5 and 2.0 M free hydrogen and between 100 ppm and 800 ppm calcium, the liquid material present in an amount capable of yielding a solution pH of 6.0 or below when present in the aqueous disinfectant composition; and
a solubilizer present in an amount between 0 vol % and 5 vol %.

2. The cleaning wipe of claim 1 wherein the cleaning substrate is one of the following: non-woven material, woven material, hydroentangled material, open-cell polymeric foam, natural sponge, synthetic sponge.

3. The cleaning wipe of claim 2 wherein the cleaning composition further comprises:
from 0.1 vol. % and 5.0 vol % of at least one antimicrobial compound derived from at least one natural material; and
a short-chain alcohol present in an amount between 0 and 50 vol %.

4. The cleaning wipe of claim 2, wherein the wherein the at least one natural compound derivative has the general formula: 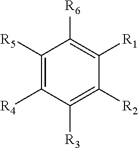
wherein R₁ is one of —OH, an alkenyl group having between 3 and 10 carbon atoms, or an alkoxyl group having between 1 and 5 carbon atoms;
R₂ is one of an alkyl group having between 1 and 10 carbon atoms, or an alkoxy group having between 2 and 5 carbon atoms;
R₃ and R₆ is hydrogen;
R₄ is hydrogen, or an alkenyl group having between 3 and 10 carbon atoms and at least one double bond; and
R₅ is hydrogen or an alkoxy group having between 1 and 5 carbon atoms.

5. The cleaning wipe of claim of claim 4 wherein the at least one natural compound of the cleaning composition is selected from the group consisting of phenylpropanoids, monoterpenoid phenols, and mixtures thereof.

6. The cleaning wipe of claim 4 wherein the at least one naturally derived compound of the cleaning composition is selected from the group consisting of thymol, carvarol, cinnamaldehyde, eugenol and mixtures thereof.

7. The cleaning wipe of claim 1 wherein the solubilizer of the cleaning composition is a surfactant surfactant-hydrotrope selected from the group consisting of anionic surfactants, nonionic surfactants, zwitterionic surfactants or mixtures thereof.

8. The cleaning wipe of claim 1 wherein the solubilizer of the cleaning composition is a zwitterionic surfactant selected from the group consisting of lauryldimethylamine oxide, myristamine oxide, alkyl imidazolines, alkyl amines, and mixtures thereof.

9. The cleaning wipe of claim 1 wherein the solubilizer of the cleaning composition is an anionic surfactant selected from the group consisting of alkyl sulfonates and alkyl aryl sulfonates having about 8 to about 22 carbon atoms in the alkyl portion, alkali metal salts or mixtures thereof.

10. The cleaning wipe of claim 1 wherein the solubilizer of the cleaning composition is a nonionic surfactant is selected from the group consisting of ethylene oxide adducts of C₈ to C₁₂ alcohols, ethylene oxide/propylene oxide adducts of ethylene glycol, alkylene glycols, and mixtures thereof.

11. The cleaning wipe of claim 1 wherein the liquid material in the cleaning composition has between 0.5 and 2.0 M free hydrogen and between 100 ppm and 800 ppm calcium, the liquid material present in an amount capable of yielding a solution pH of 6.0 or below when present in the composition and is present in an amount between 0.25 vol % and 20 vol %.

12. The cleaning wipe of claim 11 wherein the liquid material includes a compound having the general formula:
$$[ {H}_{x} {O}_{\frac{( x - 1 )}{2}} + {( {H}_{2} O )}_{y} ] Z$$
wherein x is an odd integer ≥3;
y is an integer between 1 and 20; and
Z is a polyatomic ion or monoatomic ion

13. The cleaning wipe of claim 12 wherein the wherein Z is one of a monoatomic ion from Groups 14 through 17 having a charge value between −1 and −3 or a polyatomic ion having a charge between −1 and −3 and x is an integer between 3 and 11 and y is an integer between 1 and 10.

14. The cleaning wipe of claim 13 wherein Z is selected from the group consisting of sulfate, carbonate, phosphate, oxalate, chromate, dichromate, pyrophosphate and mixtures thereof.

15. The cleaning wipe of claim 1 wherein the liquid material in the cleaning composition comprises a stoichiometrically balanced chemical composition of at least one of the following: hydrogen (1+), triaqua-μ3-oxotri sulfate (1:1); hydrogen (1+), triaqua-μ3-oxotri carbonate (1:1), hydrogen (1+), triaqua-μ3-oxotri phosphate, (1:1); hydrogen (1+), triaqua-μ3-oxotri oxalate (1:1); hydrogen (1+), triaqua-μ3-oxotri chromate (1:1) hydrogen (1+), triaqua-μ3-oxotri dichromate (1:1), hydrogen (1+), triaqua-μ3-oxotri pyrophosphate (1:1), and mixtures thereof.

16. The cleaning wipe of claim 1 wherein the cleaning composition further comprises at least one weak organic acid is present in an amount between 0.1 and 5 vol %.

17. The cleaning wipe of claim 16 wherein the at least one weak organic acid is selected from the group consisting of acetic acid, hydroxyacetic acid, citric acid, tartaric acid, maleic acid, furmaric acid and mixtures thereof.

18. The cleaning wipe of claim 1 wherein the cleaning composition further comprises a carboxylic acid compound having the general formula: 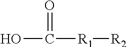
wherein R₁ is an unsaturated hydrocarbon moiety having between four and fourteen carbon atoms or a hydrocarbon moiety having between four and fourteen carbon atoms and at least one double bond; and
wherein R₂ is a one of —H, —OH, or —CH₃;
wherein the carboxylic acid component is present in an amount between 0.1 vol % and 3 vol %.

19. The cleaning wipe of claim 18 wherein the carboxylic acid compound is selected from the group consisting of hexanoic acid, octanoic acid, decanoic acid, dodecanoic acid and mixtures thereof.
